(19) United States
(12) Patent Application Publication
(10) Pub. No.: US 2004/0044438 A1
(43) Pub. Date: Mar. 4, 2004

(54) Point-of-sale tape measure dispenser

(75) Inventors: Steven Charles Lorraine, Glastonbury, CT (US); Miguel A. Nistal, Avon, CT (US); Robert Leo Scillia, West Hartford, CT (US); John C. Murray, Canton, CT (US)

Correspondence Address: PILLSBURY WINTHROP, LLP, P.O. BOX 10500, MCLEAN, VA, 22102, US

(73) Assignee: THE STANLEY WORKS, New Britain, CT

(21) Appl. No.: 10/465,777

(22) Filed: Jun. 20, 2003

Related U.S. Application Data
(60) Provisional application No. 60/391,232, filed on Jun. 26, 2002.

(51) Int. Cl. G06F 17/00

(52) U.S. Cl. 700/236

(57) ABSTRACT

The invention provides a method of selling tape measures. The tape measures are contained within a point-of-sale vending device (i.e., a vending machine), and are dispensed individually when purchased by a user. Several varieties of tape measure may be included within the vending device. The vending device may allow the user to purchase tape measures using cash, credit cards, debit cards, store credit cards and automated clearing house transactions. Additionally, the vending device may be networked to a central inventory control computer to assist a retail store with inventory control and revenue tracking. Within the vending device, the tape measures may be unpackaged, resulting in a cost savings for the manufacturer. Because the tape measures are dispensed only when purchased and are inaccessible until then, theft of tape measures may be reduced or eliminated.

This application claims priority to U.S. provisional application No. 60/391,232, filed Jun. 26, 2002, the entire content of which is hereby incorporated by reference.

### BACKGROUND OF THE INVENTION

1. Field of the Invention

The invention relates generally to methods for selling hand tools, and more particularly, to methods for selling tape measures.

2. Description of Related Art

Tape measures are hand tools that include a coilable tape rule encased within a housing. These hand tools are used in a great variety of industrial and personal measuring tasks. To support the many applications in which tape measures are used, many different types of tape measures are available, each with different features to suit different user needs. For example, tape measures may include automatic re-coiling of the tape, length locking features, and metal or plastic housings of various colors. In addition, tape measures come in various tape blade widths, with various gripping features on the housing, and are offered with rulings in a number of measurement systems.

Unfortunately, tape measures pose a significant theft problem in retail stores. Thieves have been known to rip conventionally packaged tape measures (e.g., packaged in cardboard-backed blister pack) out of their packages and then simply wear the stolen tape measures out of the store, usually clipped to the thief's belt. In order to control this theft problem, electronic article surveillance (EAS) tags are typically installed in tape measure packages. However, the EAS tags are useless if a tape measure is separated from its package.

As one solution to the theft problem, commonly assigned U.S. Pat. No. 6,011,472 to Pendergraph et al. discloses a theft-deterrent tape measure package. In the tape measure package of this reference, an EAS tag is provided in a separate compartment of the package and the package is constructed of a strong plastic material that is difficult to cut without a sharp blade. Although this type of theft-deterrent packaging may deter the conventional mode of tape measure theft, tape measure theft remains a problem.

### SUMMARY OF THE INVENTION

One aspect of the invention relates to a point-of-sale vending device containing therein a plurality of tape measures. In embodiments of the invention, the point-of-sale vending device is configured and adapted to dispense one or more of the plurality of tape measures upon payment of a predetermined amount. The payment may be in cash, credit, debit or automated clearing house transaction form. The point-of-sale vending device may be connected to an electronic payment authorization system by a network connection. The point-of-sale vending device may include its own inventory control system, and may be connected to a centralized inventory control system.

Another aspect of the invention relates to a tape measure inventory control system. The tape measure inventory control system comprises a point-of-sale vending device containing a supply of tape measures. The point-of-sale vending device is configured and adapted to dispense one or more of the supply of tape measures upon payment of a predetermined amount and to establish signals representative of one or more of a number of tape measures dispensed, type of tape measures dispensed, or times at which tape measures are dispensed. A centralized inventory control system is in communication with the point-of-sale vending device to receive the signals.

A further aspect of the invention relates to a method for selling tape measures. The method comprises installing the tape measures securely within a point-of-sale vending device configured and adapted to process financial transactions and causing the point-of-sale vending device to dispense one or more of the tape measures upon completion of a successful vending device financial transaction.

Yet another aspect of the invention also relates to a method for selling tape measures. The method comprises stocking a plurality of different types of tape measures within a point-of-sale vending device. The tape measures are devoid of any individual theft deterrent mechanism and are inaccessible until a user completes a financial transaction. The method further comprises dispensing one or more of the tape measures after successful completion of the financial transaction.

### BRIEF DESCRIPTION OF THE DRAWINGS

The invention will be described with reference to the following drawings, in which like numerals represent like features throughout the several views, and in which:

FIG. 1 is a perspective view of a point-of-sale vending device adapted to dispense tape measures in accordance with an embodiment of the invention; and

FIG. 2 is a high-level block diagram of a sale and dispensing procedure according to the present invention.

### DETAILED DESCRIPTION

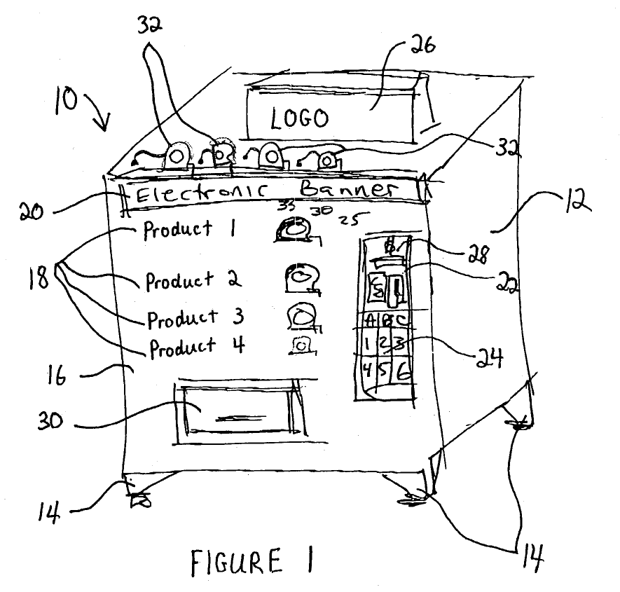

One embodiment of the invention is illustrated in FIG. 1, which is a perspective view of a point-of-sale vending device, generally indicated at 10, that dispenses tape measures. The point-of-sale vending device 10 illustrated in FIG. 1 may be specially adapted to dispense tape measures, or may be a modified or unmodified conventional type of vending device.

Conventional types of vending devices are generally used for food and other small items, and are disclosed in, for example, U.S. Pat. Nos. 4,730,750, 4,927,051, 5,730,316 and 5,806,712, the disclosures of which are incorporated by reference herein. The vending device 10 may incorporate some of the features and functional attributes of these patents, but is more particularly adapted to sell and dispense several varieties of tape measures. The vending device 10 is comprised of a cabinet 12, which preferably contains a plurality of each variety of tape measure that is to be sold. The cabinet 12 may be comprised of a suitable metal material, such as sheet steel or aluminum. The cabinet 12 may be manufactured by any of a number of well known sheet metal forming processes. Four legs 14 are provided on the bottom of the cabinet 12 (only three of the legs 14 are visible in the perspective view of FIG. 1). The legs 14 may be integrally formed with the cabinet 12 or connected to the cabinet in some other way, such as by bolts, adhesives, or weldments. In order to prevent tipping and other unwanted movement, the legs 14 may be bolted to the floor surface on which they rest to secure the vending device 10. Alternatively, a portion of the cabinet 12 may include a fitting through which a chain may be passed to secure the vending device 10 to an external stationary object, such as a structural pillar or a wall.

The front face 16 of the cabinet 12 provides the product display and the user interface features of the vending device 10. In the embodiment shown, the front face 16 is a solid sheet of material with cut-outs provided for the installation of the user interface components, which components will be described below. In the illustrated embodiment, the product descriptions, indicated at 18, are painted, printed, or electronically displayed on the front face 16, although in other embodiments, the products themselves may be directly visible inside the cabinet 12 through a sheet of transparent material provided as a portion of the front face 16. In FIG. 1, four products (each a different type of tape measure) are for sale, although more or fewer products may be included in the vending device 10, depending on its design. In the preferred embodiment, one or more of the tape measures sold by The Stanley Works (New Britain, Conn., USA) under the brand names POWERLOCK®, LEVERLOCK®, MAXSTEEL™, and FATMAX™ are within the vending machine and available for sale. The features of these products are described in commonly assigned U.S. Pat. Nos. 4,434,952, 4,972,601, 4,930,227, 4,153,996, 5,746,004, and 6,324,769, the disclosures of which are incorporated by reference herein. Typically, one product description 18 would be provided for each variety of tape measure that is sold and dispensed by vending device 10.

The vending device 10 includes several features that are useful for advertising purposes. An electronic programmable banner device 20 is installed in the front face 16 and covers an upper portion thereof. The electronic banner device 20 may display advertising slogans or other product information, and may be programmed to scroll and/or cycle through several advertising slogans. Depending on the type of vending device 10, the electronic banner device 20 may be programmed from a keyboard or other input device on its reverse, may provide an input for programming instructions from an external source (such as a laptop computer temporarily connected thereto), or may be programmed via the keypad 24 of the vending device 10. (The keypad 24 will be described in more detail below.)

The vending device 10 also includes a top display 26, which provides space for the display of a company logo. The top display 26 may be comprised of sheets of metal material, like the cabinet 12, or it may be comprised of sheets of translucent material, such as glass or poly(methyl methacrylate). If the top display 26 is comprised of translucent material, a lighting source may be installed within it in order to illuminate the logo on the faces of the top display 26.

As an additional advertising feature, vending device 10 may include tethered product samples 32 connected thereto. Tethered product samples 32 allow the user to test the various features and attributes of the tape measures that are for sale to determine which variety would be most suitable for the user. In vending device 10, product samples 32 are tethered to the cabinet 12 of the vending device 10 at a top surface thereof, although if tethered product samples 32 are provided, they may be tethered to any suitable portion of the cabinet 12. The tethers for the product samples 32 may be steel cables or other theft-deterring attachments. One of ordinary skill in the art will realize that the advertising features described above are optional.

The vending device 10 is controlled by a transaction processing device 22, the keyboard 26 of which is accessible on the front face 16 of the cabinet 12. The transaction processing device 22 is a computer that records a user product selection, processes the user's method of payment, and causes the tape measure to be released to the user. The term “computer” as used herein is meant to encompass an interactive instruction processing system including a keyboard or other input mechanism and a display or other output mechanism, which are coupled to some form of electronic memory (e.g., RAM, ROM, PROM, EEPROM, etc.) and a processing circuit. The processing circuit may be a microprocessor, an ASIC, a general-purpose integrated circuit or some other processing circuit. Product information and pricing is stored within the memory of the transaction processing device 22.

The transaction processing device 22 is coupled to a payment accepting mechanism 28. The payment accepting mechanism 28 may be configured to accept both currency payment and credit/debit card payment, using any one of a number of bill accepting and credit card accepting mechanisms that are well known in the art. In particular, the transaction processing device 22 and payment accepting mechanism 28 may be configured to accept credit cards, debit cards, particular store credit cards, cash, and ACH (automated clearing house) transfers from checking accounts. The transaction processing device 22 may include a small LCD or LED screen to display pricing and status information, or may be coupled to the electronic banner device 20 to display this information.

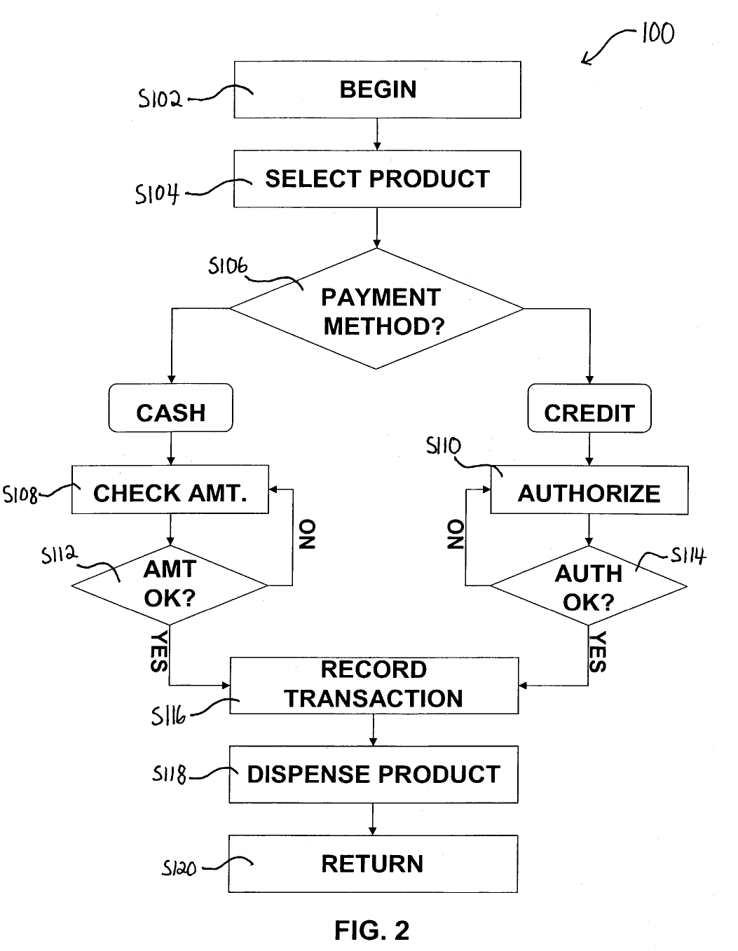

The tape measure vending process, and certain operational features of the vending device 10, are better described with reference to the high-level schematic block diagram of FIG. 2. FIG. 2 illustrates a process 100 for vending a tape measure, which begins at S102, and continues at S104. At S104, the user compares the product descriptions 18 and chooses a tape measure by inputting the appropriate product identifier using the keypad 24. The product identifier may be numeric or alphanumeric depending on the type of keys provided on the keyboard 24.

Once a product is selected, process 100 continues with S106, in which the transaction processing device 22 queries the user as to which payment method will be used (e.g., by providing the user with an opportunity to either swipe a credit/debit card or insert a bill into a the payment accepting mechanism 28). Once a payment input is detected, process 100 will branch to either S106:CASH (cash payment) or S106:CREDIT (credit/debit/ACH payment). If the payment is by cash, process 100 continues with S108, in which the transaction processing device 22 determines the amount of the payment. If the payment is by credit or debit, process 100 continues with S110, in which the credit or debit payment is authorized by contacting the appropriate authorizing agency. After checking the amount of the cash payment or authorizing the credit or debit payment, the transaction processing device compares the payment to the tape measure's cost in S112 (for cash payments) or confirms the credit/debit authorization in S114 (for credit/debit payments). If the payment amount is correct (S112:YES) or the authorization is correct (S114:YES), process 100 continues with S116. Otherwise, process 100 returns to S108 (via S112:NO) or S110 (via S114:NO).

At S116, the transaction processing device 22 records the transaction. In one embodiment, recording the transaction may involve recording that a particular tape measure has been dispensed in the internal memory of the transaction processing device 22. In this embodiment, the transaction processing device 22 would be programmed with the number of tape measures of each particular type that are initially stocked in the vending device 10. The transaction processing device 22 would then subtract from the programmed initial number each time a tape measure was purchased, and would display a message or otherwise indicate when a particular type of tape measure was out of stock.

In another embodiment, the vending device 10, and more specifically, the transaction processing device 22, may be connected to, and communicate directly with, a centralized inventory control program. Such centralized inventory control programs typically run on, for example, a mainframe computer system in a retail store. In this embodiment, the centralized inventory control system for the store would be automatically notified by the transaction processing device 22 when particular types of tape measures are out of stock and need to be reordered. Alternatively, the transaction processing device may communicate remotely (e.g., through a network connection, as will be described below) directly with the manufacturer of the tape measures for inventory control. Additionally, the centralized inventory control system for the store may be notified of each sale on a real time basis in order to provide instantaneous sales and revenue tracking.

In either variation, the information stored within the vending device 10 or transmitted to the centralized inventory control program or the manufacturer may include the number and types of tape measures sold and the time at which those tape measures were sold. In addition, the vending device 10 may be configured to directly store or calculate any conventional sales metric. For example, based on the times at which tape measures were sold, either the vending device 10 or the central inventory control program may perform an analysis to determine when tape measures are most often sold, or the aggregate amount of tape measure sales per day.

As will be realized from the description above, it is also preferable if the transaction processing device 22 is provided with a network connection to a credit/debit card authorization computer system, so that credit and debit card transactions can be processed in real time in S114. If a network connection is not provided for this purpose, the credit/debit card authorizations would not be processed in S114, and instead, the transaction processing device would simply record the credit/debit card number for later processing and optionally, would run checksums or other local verification procedures on the number.

Network connections provided to the transaction processing device 22 for credit/debit card processing and inventory control system interfacing may be wired or wireless in nature. Suitable examples of network connections that may be used with the transaction processing device 22 include ethernet, a conventional telephone line and modem, a satellite link (particularly suitable for credit/debit card verification), cellular-based technologies, and wireless local area network (LAN) protocols, such as the wireless LAN ANSI/IEEE 802.11(b)/(g) standards (Institute of Electrical and Electronics Engineers). One or more of these network protocols and connections may be used singularly or in combination, depending on the particular configuration of the transaction processing device 22 and the other components to which it is networked.

As shown in FIG. 2, once the transaction has been recorded at S116, process 100 continues with S118. At S118, the selected tape measure is ejected from its storage compartment inside the cabinet 16 by a suitable mechanism and is placed in the dispensing bay 30 for removal by the user. Process 100 ends at S120.

In process 100, the order of S116, the recordation of the transaction, and S118, the dispensing of the product, may be reversed. If the order of these two tasks is reversed, the product would be dispensed before the transaction is recorded. Process 100 may also include additional tasks.

A vending device 10 and process 100 according to embodiments of the invention provide several advantages when retailing tape measures. First, the tape measures are not dispensed by the vending device 10 until a transaction is complete, and are secured within the cabinet 12 until then. Therefore, it is anticipated that theft of tape measures will be more difficult. In general, EAS tags and other theft-deterrent mechanisms would not be required, resulting in a cost savings for the retailer. Additionally, as described above, the vending device 10 itself may be fixedly secured to the floor or to an external structure, making the vending device 10 difficult to tamper with (e.g., by tipping).

A second advantage of the vending device 10 and process 100 is that the individual tape measures need not be packaged in a conventional blister pack or theft-deterrent pack. Packaging materials may be reduced or entirely eliminated, thus reducing or eliminating the manufacturer's or retailer's packaging costs. For example, the individual tape measures could be entirely unpackaged, or alternatively, they could be wrapped in a thin plastic film (e.g., shrink wrap) to prevent scuffing during the dispensing process.

A third advantage is that the user is provided with a full range of payment options.

In order to provide the user with additional convenience, the vending device 10 may be sized smaller or larger for placement in any appropriate place in a retail store or other location where tape measures may be sold. For example, the vending device 10 may be placed in a location adjacent to where other hand tools are sold, or it may be placed in a conspicuous location at the front of the store (e.g., near the cashier).

While the invention has been described with reference to certain embodiments, those of ordinary skill in the art will realize that modifications and variations may be made within the scope of the invention. The embodiments described above are intended to be exemplary, rather than limiting. The full scope of the invention is defined by the appended claims.

What is claimed is:

1. A point-of-sale vending device containing therein a plurality of tape measures.

2. The point-of-sale vending device of claim 1, wherein the plurality of tape measures comprises several pluralities of different types of tape measures.

3. The point-of-sale vending device of claim 1, wherein the point-of-sale vending device is configured and adapted to dispense one or more of the plurality of tape measures upon payment of a predetermined amount.

4. The point-of-sale vending device of claim 3, wherein the point-of-sale vending device is configured and adapted to accept the payment of the predetermined amount in cash, credit, debit or automated clearing house transaction form.

5. The point-of-sale vending device of claim 4, further comprising a network connection configured and adapted to connect the point-of-sale vending device to an electronic payment authorization system.

6. The point-of-sale vending device of claim 5, further comprising an inventory control system configured and adapted to record how many tape measures are dispensed.

7. The point-of-sale vending device of claim 6, wherein the inventory control system is further configured and adapted to record types of tape measures dispensed.

8. The point-of-sale vending device of claim 7, wherein the network connection is further configured and adapted to allow the inventory control system to communicate with a centralized inventory control system.

9. The point-of-sale vending device of claim 8, wherein the inventory control system sends signals to the centralized inventory control system representative of one or more of how many tape measures are dispensed, the types of tape measures that are dispensed, or times at which tape measures are dispensed.

10. The point-of-sale vending device of claim 9, wherein the inventory control system is configured and adapted to send a signal to the centralized inventory control system when the point-of-sale vending device is sold out of one or more of the pluralities of tape measures.

11. The point-of-sale vending device of claim 1, wherein ones of the plurality of tape measures are unpackaged and devoid of any individual theft deterrent mechanism.

12. A tape measure inventory control system, comprising:
a point-of-sale vending device containing a supply of tape measures, the point-of-sale vending device being configured and adapted to dispense one or more of the supply of tape measures upon payment of a predetermined amount and to establish signals representative of one or more of a number of tape measures dispensed, types of tape measures dispensed, or times at which tape measures are dispensed; and
a centralized inventory control system in communication with the point-of-sale vending device to receive the signals.

13. The tape measure inventory control system of claim 12, wherein the centralized inventory control system is an inventory control system of a retailer.

14. The tape measure inventory control system of claim 12, wherein the centralized inventory control system is an inventory control system within the point-of-sale vending device.

15. The tape measure inventory control system of claim 12, wherein the supply of tape measures comprises one or more pluralities of different types of tape measures.

16. The tape measure inventory control system of claim 12, wherein the point-of-sale vending device is configured and adapted to accept the payment of the predetermined amount in cash, credit, debit, or automated clearing house transaction form.

17. A method for selling tape measures, comprising:
installing the tape measures securely within a point-of-sale vending device configured and adapted to process financial transactions; and
causing the point-of-sale vending device to dispense one or more of the tape measures upon completion of a successful vending device financial transaction.

18. The method of claim 1, further comprising recording that the one or more tape measures have been dispensed.

19. The method of claim 18, further comprising transmitting to a centralized inventory control system one or more of (a) the number of the one or more tape measures that have been dispensed, (b) types of the one or more tape measures that have been dispensed, or (c) times at which the one or more tape measures have been dispensed.

20. The method of claim 19, further comprising communicating to the centralized inventory control system when all of the tape measures have been dispensed.

21. The method of claim 17, wherein the financial transaction is one or more of a credit card transaction, a cash transaction, a debit card transaction, a store credit card transaction or an automated clearing house transaction.

22. A method for selling tape measures, comprising:
stocking a plurality of different types of tape measures within a point-of-sale vending device, the tape measures being devoid of any individual theft deterrent mechanism and being inaccessible until a user completes a financial transaction; and
dispensing one or more of said tape measures after completion of the financial transaction.

23. The method of claim 21, further comprising recording one or more of (a) a number of tape measures dispensed, (b) types of tape measures dispensed, or (c) times at which tape measures are dispensed in a centralized inventory control system connected to the point-of-sale vending machine.
